(19) United States
(12) Patent Application Publication
(10) Pub. No.: US 2008/0241460 A1
(43) Pub. Date: Oct. 2, 2008

(54) Trophy display apparatus

(76) Inventor: John A. Porter, Warrensburg, NY (US)

Correspondence Address: John A. Porter, Jr., 1538 Viele Pond Road, Warrensburg, NY, 12885, US

(21) Appl. No.: 12/009,068

(22) Filed: Jan. 16, 2008

Related U.S. Application Data
(60) Provisional application No. 60/880,348, filed on Jan. 16, 2007.

(51) Int. Cl. B32B 3/06

(52) U.S. Cl. 428/99

(57) ABSTRACT

A trophy display apparatus includes a trophy display board unit. A ferro-magnetic plate can be connected to the trophy display board unit. A plurality of individual trophies, each having a trophy-attached magnet, are connected to the trophy display board unit by means of magnetic attraction between the ferro-magnetic plate and the trophy-attached magnets. Each individual trophy can be a three-dimensional representation of a full head mounts corresponding to a hunted animal, bird or other species. Preferably, the trophy display board unit includes a mounting channel for mounting the trophy display board unit on a vertical wall surface. The mounting channel is located on a rear surface of the trophy display board unit. The trophy display board unit can be in a variety of ornamental forms. The displaying of the individual trophies can serve to stimulate conversations and the telling of hunting stories by the respective hunters to interested parties.

### CROSS-REFERENCE TO RELATED APPLICATION

This application claims priority based upon my copending Provisional Application Ser. No. 60/880,348; filed Jan. 16, 2007.

### BACKGROUND OF THE INVENTION

1. Field of the Invention

The present invention relates generally to devices for displaying trophies, and, more particularly, to devices especially adapted for displaying trophies on vertical surfaces.

2. Description of the Prior Art

The desirability to display plural trophies on vertical surfaces has been manifested over the years by the implementation of a number of innovations, and the following U.S. patents are representative of some of those innovations: Des. 168,375, Des. 224,838, Des. 244,733, Des. 270,121, and Des. 426,999.

More specifically, Des. 168,375 discloses a device for displaying plural ornaments on horizontally oriented shelves. Horizontally oriented shelves are well known dust collectors. In this respect, it would be desirable to provide a trophy display apparatus which does not include horizontally orientated display shelves.

Each of Des. 224,838, Des. 244,733, Des. 270,121, and Des. 426,999 discloses a hanger for plural articles in which a vertically oriented base has a plurality of mechanical hook or hook-type members projecting horizontally therefrom. Generally, hooks or hook-like projections for displaying articles require each article that is displayed to have a complementary receiver for a hook or hook-like projection. Many trophies do not have receivers for hooks or hook-like projections. In this respect, it would be desirable to provide a trophy display apparatus which can readily display trophies that do not have receivers for hooks or hook-like projections.

Still other features would be desirable in a trophy display apparatus. For example, with an article displaying device that includes a plurality of horizontally projecting hooks, when not all of the hooks are occupied with displaying an article, the non-occupied hooks may present an unesthetic appearance. In this respect, it would be desirable if a trophy display apparatus were provided which presents an aesthetic appearance even when less than the maximum number of articles are displayed.

In addition, it would be desirable if means for attaching trophies to a trophy display board were embedded inside of the trophy display board. Such an arrangement would facilitate an aesthetic outward appearance of the trophy display board.

Thus, while the foregoing body of prior art indicates it to be well known to use vertically mounted displays for plural articles, the prior art described above does not teach or suggest a trophy display apparatus which has the following combination of desirable features: (1) does not include horizontally orientated display shelves; (2) can readily display trophies that do not have receivers for hooks or hook-like projections; (3) presents an aesthetic appearance even when less than the maximum number of articles are displayed; and (4) has means for attaching trophies to a trophy display board that are embedded inside of the trophy display board. The foregoing desired characteristics are provided by the unique trophy display apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a trophy display apparatus which includes a trophy display board unit. Attachment means are connected to the trophy display board unit, for attaching a plurality of individual trophies to the trophy display board unit. A plurality of individual trophies are connected to the trophy display board unit by means of the trophy attachment means.

Preferably, the trophy display board unit includes a mounting channel for mounting the trophy display board unit on a vertical wall surface. The mounting channel is located on a rear surface of the trophy display board unit.

The trophy display board unit can include an indicia-bearing plate. The indicia-bearing plate is located on a front surface of the trophy display board unit.

The trophy display board unit can be in a variety of ornamental forms. In this respect, the trophy display board unit can be in the form of a shield or an Indian arrow head, among others.

The trophy attachment means can include a ferro-magnetic plate embedded in the trophy display board unit, and each of the individual trophies can include a trophy-attached magnet for magnetic attachment to the ferro-magnetic plate. Alternatively, mating pin or Velcro® fastener elements, or a tacky adhesive may be used for the same purpose.

The displaying of the individual trophies can serve to stimulate conversations and the telling of stories by the respective hunters to interested parties.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved trophy display apparatus which has all of the advantages of the prior art and none of the disadvantages.

It is another object of the present invention to provide a new and improved trophy display apparatus which may be easily and efficiently manufactured and marketed.

It is a further object of the present invention to provide a new and improved trophy display apparatus which is of durable and reliable construction.

An even further object of the present invention is to provide a new and improved trophy display apparatus which is susceptible of a low cost of manufacture with regard to both materials and labor, and which accordingly is then susceptible of low prices of sale to the consuming public, thereby making such trophy display apparatus available to the buying public.

Still yet a further object of the present invention is to provide a new and improved trophy display apparatus which does not include horizontally orientated display shelves.

Still another object of the present invention is to provide a new and improved trophy display apparatus that can readily display trophies that do not have receivers for hooks or hook-like projections.

Yet another object of the present invention is to provide a new and improved trophy display apparatus which presents an aesthetic appearance even when less than the maximum number of articles are displayed.

Even another object of the present invention is to provide a new and improved trophy display apparatus that has means for attaching trophies to a trophy display board that are embedded inside of the trophy display board.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the trophy display apparatus of the invention, mounted on a wall and supporting a plurality of individual trophies which depict deer.

FIG. 2 is a side view of the embodiment of the trophy display apparatus shown in FIG. 1 taken along line 2-2 of FIG. 1.

FIG. 3 is a rear view of the embodiment of the trophy display apparatus of FIG. 2 taken along line 3-3 thereof.

FIG. 4 is an exploded side view of the embodiment of the invention shown in FIG. 2, illustrating how one individual trophy is to be mounted on the apparatus by means of magnetic attachment.

FIG. 5 is a trophy depicting a bear.

FIG. 6 is a trophy depicting a buffalo.

### DESCRIPTION OF THE PREFERRED EMBODIMENT

With reference to the drawings, a new and improved trophy display apparatus embodying the principles and concepts of the present invention will be described.

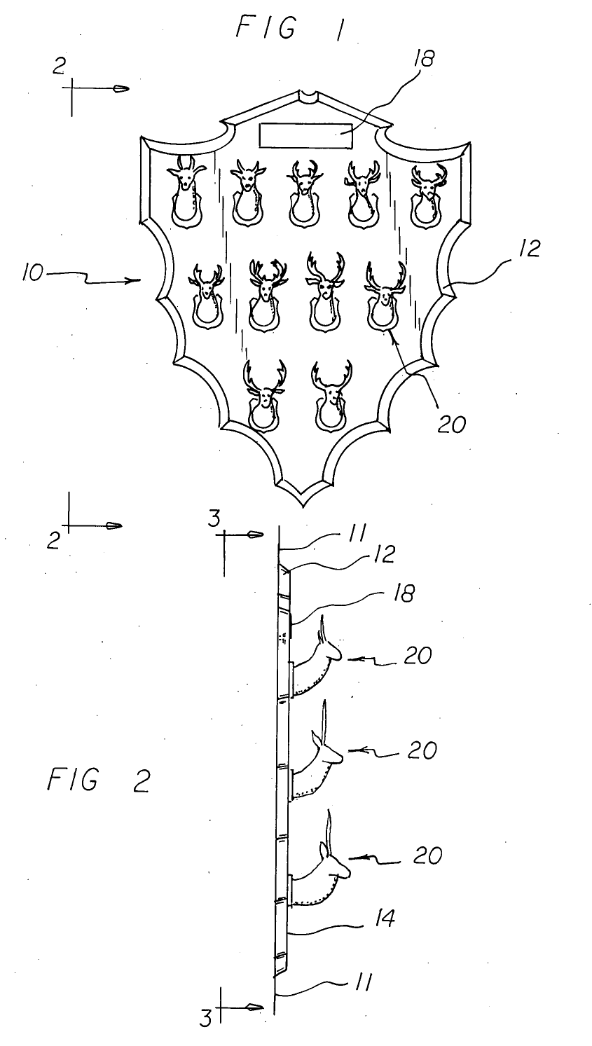

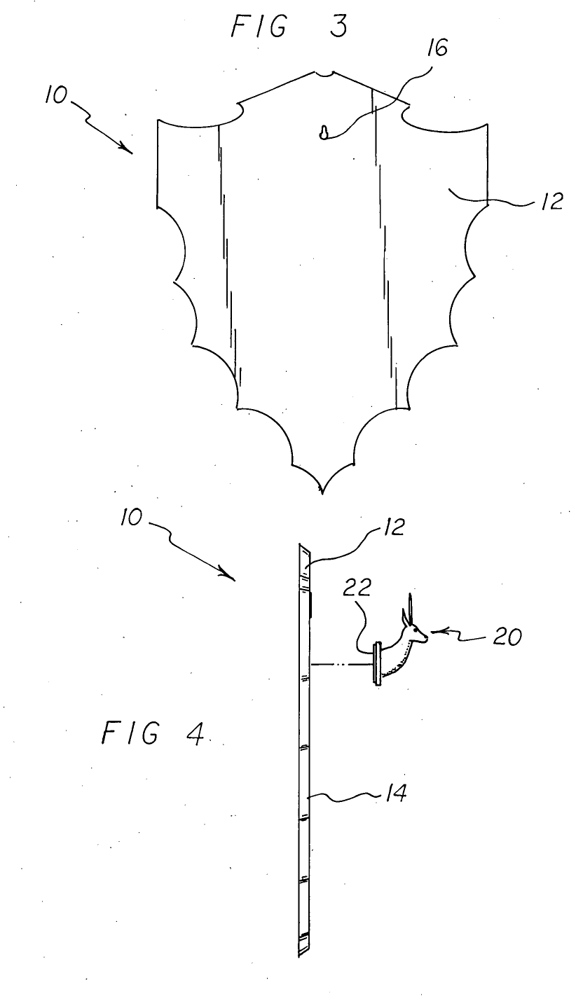

Turning to FIGS. 1-4, there is shown a preferred embodiment of the trophy display apparatus of the invention generally designated by reference numeral 10. In each of the figures, reference numerals are shown that correspond to like reference numerals that designate like elements shown in other figures.

In the preferred embodiment, a trophy display apparatus 10 includes a trophy display board unit 12. Attachment means are connected to the trophy display board unit 12, for attaching a plurality of individual trophies 20 to the trophy display board unit 12. A plurality of individual trophies 20 are connected to the trophy display board unit 12 by means of the trophy attachment means.

Preferably, the trophy display board unit 12 includes a mounting channel 16 for mounting the trophy display board unit 12 on a vertical wall surface 11. If desired, the trophy display board unit 12 can be mounted on the vertical wall surface 11 by other well-known wall mounting means. The mounting channel 16 is located on a rear surface of the trophy display board unit 12.

The trophy display board unit 12 can include an indicia-bearing plate 18. The indicia-bearing plate 18 can bear the name of a hunter by whom the respective individual trophies 20 have been earned. The indicia-bearing plate 18 is located on a front surface of the trophy display board unit 12. The trophy display board unit 12 can be in a variety of ornamental forms. In this respect, the trophy display board unit 12 can be in the form and configuration of a shield. Optionally, the trophy display board unit 12 can be in the form of an Indian arrow head.

The trophy attachment means can include a ferro-magnetic plate 14 embedded in the trophy display board unit 12, and each of the individual trophies 20 can include a trophy-attached magnet 22 for magnetic attachment to the ferro-magnetic plate 14.

To use the trophy display apparatus 10 of the invention, a nail (not shown) can be driven into the vertical wall surface 11, and the trophy display apparatus 10 can be hung on that nail by guiding the mounting channel 16 onto that nail.

When respective individual trophies 20 are earned, the respective individual trophies 20 can be placed on the trophy display board unit 12, such that the trophy-attached magnets 22 in the individual trophies 20 are attracted to the ferro-magnetic plate 14 in the trophy display board unit 12, whereby the individual trophies 20 are secured to the trophy display board unit 12 by magnetic attraction.

In FIGS. 1, 2, and 4, the individual trophies 20 depict deer. Alternatively, the individual trophies 20 can depict other animals that have antlers, such as moose, elk, and caribou, among others. Finally, It will be appreciated that birds or other wildlife species may be memorialized in substantially the same manner as well.

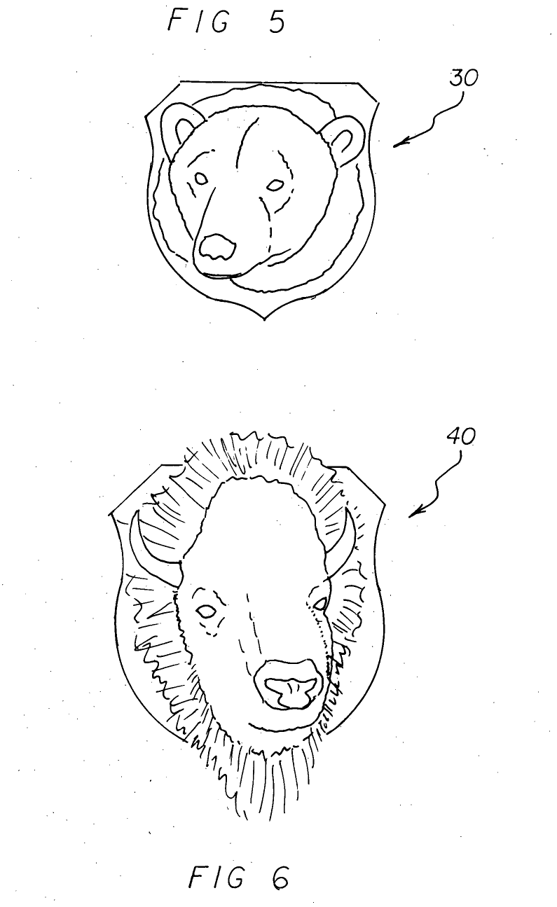

In FIG. 5, a trophy depicts a bear 30.

In FIG. 6, a trophy depicts a buffalo 40.

Alternatively, instead of using magnetic attachment means, the trophy attachment means can includes pins (not shown) that project outward from the trophy display board unit 12. In this respect, each of the individual trophies 20 can include pin-reception channel (not shown) for receiving a selected pin projecting outward from the trophy display board unit 12. Similarly, mating Velcro® fastener elements, or a tacky adhesive may optionally be used for the same purpose.

The trophy display apparatus 10 of the invention can display individual trophies 20 that represent game animals that have been killed or captured by one or more hunters. The individual trophies 20 can be three-dimensional representations of full head mounts of a hunted animal, bird or other wildlife species, substantially as depicted in the drawings. In addition, the displaying of the individual trophies 20 can serve to stimulate conversations and the telling of hunting stories by the respective hunters to interested parties.

The components of the trophy display apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved trophy display apparatus that is low in cost, relatively simple in design and operation, and which may advantageously be used without including horizontally orientated display shelves. With the invention, a trophy display apparatus is provided which can readily display trophies that do not have receivers for hooks or hook-like projections. With the invention, a trophy display apparatus is provided which presents an aesthetic appearance even when less than the maximum number of articles are displayed. With the invention, a trophy display apparatus is provided which has means for attaching trophies to a trophy display board that are embedded inside of the trophy display board.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A trophy display apparatus, comprising:
a trophy display board unit,
attachment means, connected to said trophy display board unit, for attaching a plurality of individual trophies to said trophy display board unit, and
a plurality of individual trophies connected to said trophy display board unit by means of said trophy attachment means.

2. The apparatus of claim 1 wherein said trophy display board unit includes a mounting channel for mounting said trophy display board unit on a vertical wall surface.

3. The apparatus of claim 2 wherein said mounting channel is located on a rear surface of said trophy display board unit.

4. The apparatus of claim 1 wherein said trophy display board unit includes an indicia-bearing plate.

5. The apparatus of claim 4 wherein said indicia-bearing plate is located on a front surface of said trophy display board unit.

6. The apparatus of claim 1 wherein said trophy display board unit is in the form of a shield.

7. The apparatus of claim 1 wherein:
said trophy attachment means include a ferro-magnetic plate embedded in said trophy display board unit, and
each of said individual trophies includes a trophy-attached magnet for magnetic attachment to said ferro-magnetic plate.

8. The apparatus of claim 1 wherein each of said plurality of individual trophies comprises a three-dimensional representation of a full head mount of a hunted animal, bird or other wildlife species.
